(19) United States
(12) Patent Application Publication
(10) Pub. No.: US 2002/0121474 A1
(43) Pub. Date: Sep. 5, 2002

(54) Replaceable square, pleated filter cartridge

(76) Inventor: Douglas Cullen, Ontario, NY (US)

Correspondence Address: Shlesinger, Fitzsimmons & Shlesinger, 183 East Main Street, 1323 Alliance Building, Rochester, NY, 14604, US

(21) Appl. No.: 09/798,215

(22) Filed: Mar. 5, 2001

(51) Int. Cl. B01D 27/06

(52) U.S. Cl. 210/493.1

(57) ABSTRACT

A filter cartridge is made from an elongate, rectangularly shaped, pleated filter element that is secured at opposite ends thereof in a pair of end caps. The cartridge is removably mounted in a filter housing sealingly to surround an elongate, perforated, square-shaped element that is fixed in the housing to have one end of its central opening connected through a central opening in one of the cartridge end caps, and through an outlet opening in the housing with apparatus that is operable to draw fluid into the housing and through the pleated filter element to the outlet opening.

### BACKGROUND OF THE INVENTION

This invention relates to fluid filters, and more particularly to an improved air and gas filter. Even more particularly this invention relates to an improved filter of the type described having a replaceable, coreless filter cartridge which is square or rectangular in configuration and contains a pleated filter pack.

It is quite customary in various manufacturing and research ambients to utilize air or gas filter apparatus to prevent occupants of a given area from being exposed to possible harmful elements borne by the surrounding air. Particularly in the case of apparatus for filtering air, as distinguished from some other form of gas, it is most desirable that the air flow be maintained at a rather high CFM (cubic feet per minute). It is desirable also that the element filtering the air present a rather large surface area so that, while maintaining the desired flow rate, the air nevertheless is carefully filtered.

Heretofore with apparatus of the type described, it has been customary to employ one or more filter cartridge assemblies through which the air that is to be filtered is circulated. Often such cartridges are removably mounted in the associated assemblies so that they may be replaced when they become excessively dirty or clogged. Unfortunately, however, prior such replaceable cartridges have included an integral, central core, and have been rather difficult to manufacture and very expensive to replace.

It is an object of this invention, therefore, to provide an improved air or gas filter assembly, and in particular an assembly containing a removable, coreless filter cartridge that is substantially more inexpensive to manufacture and replace, then prior such air or gas filter cartridges.

Still another object of the invention is to provide an improved filter assembly of the type described in which a pleated filter cartridge is removably mounted in the assembly around a rigid, perforated basket section which is fixed in the assembly and is not replaceable with the cartridge.

Still a further object of this invention is to provide an improved filter assembly of the type described having therein a square, perforated basket section which is fixed to the assembly, and which is surrounded by a removable, similarly shaped pleated filter cartridge.

Other objects of the invention will be apparent hereinafter from the specification and from the recital of the appended claims, particularly when read in conjunction with the accompanying drawings.

### SUMMARY OF THE INVENTION

A rigid base plate having therethrough a central, substantially rectangularly shaped opening is secured in an elongate filter housing adjacent one end thereof Secured at one end thereof to the base plate around its central opening and extending therefrom toward the opposite end of the housing is an elongate, rectangularly shaped, perforated element having therethrough a central opening that registers with the opening in the base plate. Surrounding perforated element in spaced relation thereto is a removable, rectangularly shaped filter cartridge in the form of a pleated, rectangularly shaped filter element opposite ends of which are secured in a pair of rectangularly shaped end caps having therethrough rectangularly shaped openings which register with the central openings in the base plate and perforated element. A fin assembly, which is secured in the central opening in the perforated element in the form of a pair of intersecting, planar partitions, functions removably to support a cover plate sealingly over the cap at one end of the cartridge releasably to secure the cap at the opposite end of the cartridge against the base plate with the opening therein disposed in communication with apparatus for drawing fluid into the housing and successively through the pleated filter element and perforated element to the fluid outlet.

### THE DRAWINGS

FIG. 1 is a side elevational view of a filter made according to one embodiment of this invention, portions of the filter being broken away and shown in section for purposes of illustration, and support for the filter housing being shown in phantom by broken lines;

FIG. 2 is a sectional view taken generally along the line 2-2 in FIG. 1 looking in the direction of the arrows, portions of the filter again being broken away and shown in section; and

FIG. 3 is a sectional view of the filter taken along the line 3-3 in FIG. 1 looking in the direction of the arrows.

### PREFERRED EMBODIMENTS OF THE INVENTION

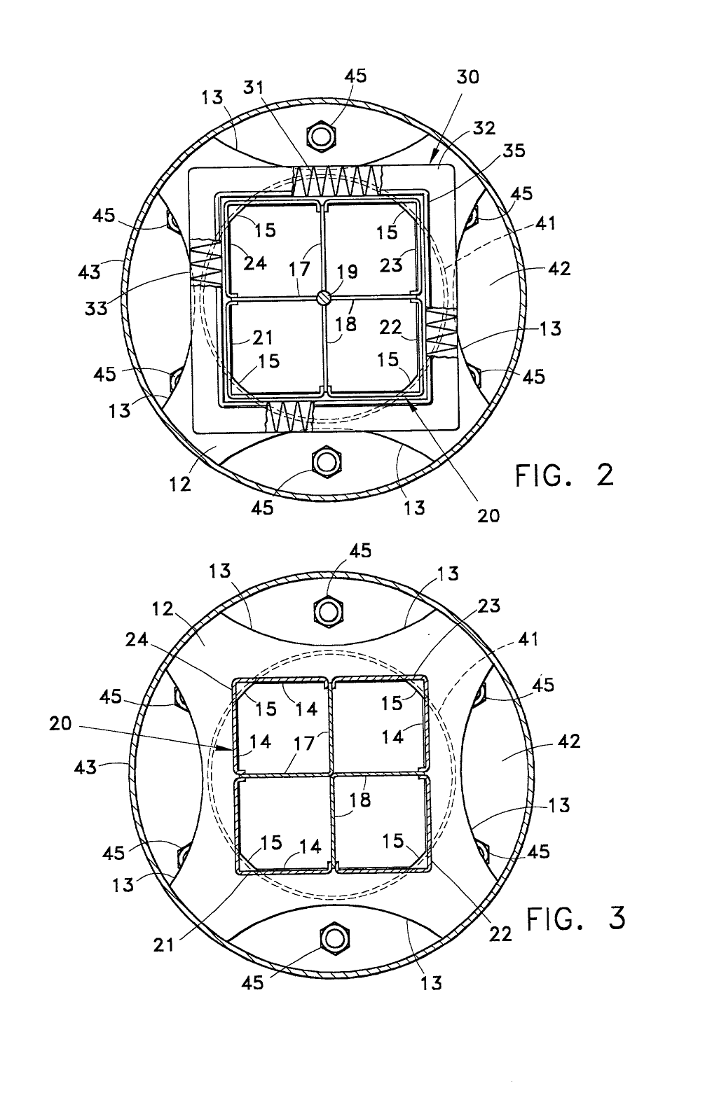

Referring now to the drawings by numerals of reference, 10 denotes generally a filter unit comprising a circular, metal base plate 12 of steel, or the like, having therein at ninety degree intervals about its axis four, like, equi-angularly spaced arcuate recesses 13 (FIGS. 2 and 3). Inwardly of the arcuate recesses 13 plate 12 has therethrough a central opening, which for the most part is rectangular in configuration, thereby forming in plate 12 four linear sidewall sections 14 (FIG. 3) opposite ends of which would normally intersect each other at right angles. However, instead of intersecting each other at right angles, in this opening opposite ends of the linear sidewalls 14 are connected to adjacent sections 14 by arcuate sections 15 which lie in a circle disposed coaxially of the axial centerline of plate 12.

Secured at its lower end, and extending slightly beneath the bottom of the central opening in the plate 12 is an elongate fin assembly in the form of two, like, rectangularly shaped steel sheets 17 and 18 (FIGS. 2 and 3). The sheets 17 and 18, each of which is approximately as wide as the distance separating a pair of spaced, parallel, confronting sides 14 of the opening in plate 12, are folded or bent medially of their longitudinal side edges into right angular configurations, as shown more clearly in FIG. 3. The two folded plates 17 and 18 are welded together along their fold line so that each half of the now-folded sheet 17 is disposed in registering, coplanar relation with a different one of the two halves of the folded sheet 18. The lower ends of the now-welded together sheets 17 and 18 are inserted into the central opening of the plate 12 so that the sheets 17 and 18 extend slightly beneath the bottom of plate 12, and are welded to the linear surfaces 14 of the opening. The fin assembly consisting of welded plates 17 and 18 now projects above the base plate 12 to a height or distance which, by way of example, could be in the range of sixteen inches. Also, for a purpose noted hereinafter a short externally threaded stud 19 is welded at one end to the juncture of plates 17 and 18 at the upper ends thereof.

Above the plate 12 the fin assembly 17, 18, is enclosed within a perforated basket section of the filter unit. This basket section, which is denoted generally by numeral 20, comprises four, like, perforated steel sheets 21, 22, 23 and 24 having therethrough numerous closely spaced apertures. Each of the sheets 21-24 has a length slightly less than those of the sheets 17 and 18, and a width slightly greater than that of the sheets 17 and 18. Medially of its longitudinal side edges, each of the sheets 21-24 is folded into right angular, cross sectional configuration. The right-angularly shaped plates 21 through 24 are secured, as by welding, at their lower ends on the upper surface of plate 12 to form a substantially square enclosure about the basket section formed by the right angularly shaped plates 17 and 18. In addition to being secured on the upper surface of plate 12, each plate 21 through 24 has marginal portions of its longitudinal side edges bent to form longitudinally extending flange sections which are welded to the outer edges of the plates 17 and 18 at opposite sides thereof As shown more clearly in FIG. 3, a marginal portion of plate 17 along one longitudinally extending edge thereof is secured between confronting, flanged edges of plates 23 and 24, while a marginal portion of the other longitudinally extending edge thereof is secured between flanged, confronting edges of plates 21 and 24. On the other hand a marginal portion of plate 18 adjacent one edge thereof is secured between flanged, confronting ends of plates 22 and 23, while a marginal portion of the other longitudinally extending edge of plate 18 is secured between flanged, confronting edges of plates 21 and 22. As a result, the perforated plates 21 through 24 are secured rigidly in a rectangular or nearly square configuration about the fin assembly formed by plates 17 and 18, which in turn form two planar partitions that intersect each other at right angles at the center of section 20, and each of which extends at right angles between a pair of sidewalls of section 20.

Removably mounted around the outside of the perforated, rectangularly shaped basket section 20 is a removable, coreless filter cartridge denoted generally by the numeral 30. Cartridge 30 comprises an elongate, pleated filter element 31, which may be made of paper, synthetic media, fiber glass, or the like, and which is rectangular in configuration, having in the center thereof a large rectangular opening for accommodating the perforated basket section 20 of the filter unit. Opposite ends of the pleated filter element 31 are secured or potted into a pair of flexible, plastic end caps 32 and 33, which also are of rectangular configuration similar to that of the filter element 31, and which have therethrough large rectangular openings for accommodating basket 20. The bottom end cap 33 has projecting from its outer surface around and adjacent to its central opening a rectangularly shaped boss 34 disposed in releasable, sealing engagement with the upper surface of base plate 12. The upper end cap 32 also has projecting from its upper surface adjacent the rectangular opening therein a rectangularly shaped boss 35, which is disposed to be sealingly engaged by the underside of a rectangularly shaped cover plate 36 having therein a central opening for accommodating the upper end of the stud 19. In use, the cover plate 36 is secured snugly and releasably over the upper end cap 32 by a nut 37 which threads onto the upper end of the stud 19 to secure plate 36 removably and snugly against the cartridge 30, thereby maintaining alternate fold or pleat lines of the filter element 31 disposed in closely spaced confronting relation to the perforated housing 20.

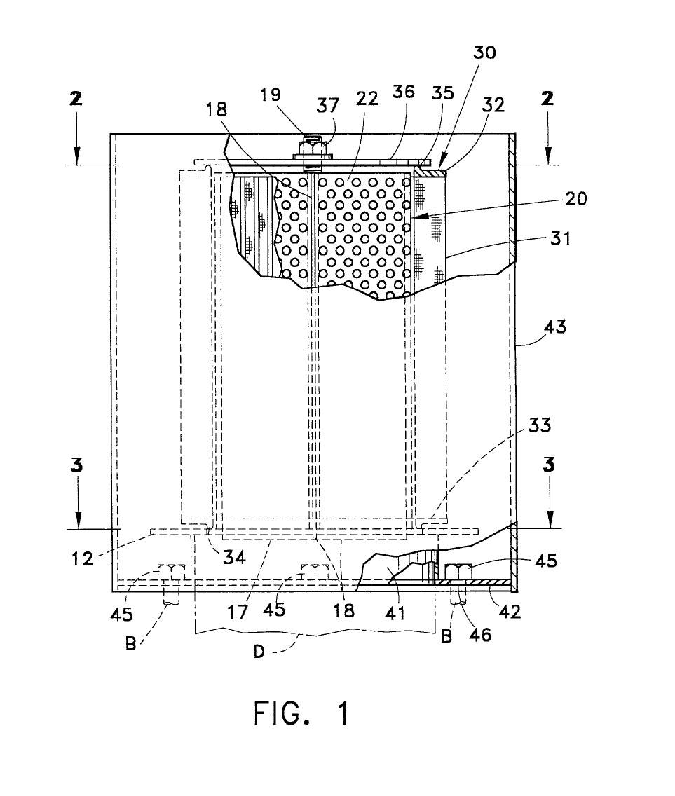

Secured at its upper end, as by welding or the like, coaxially to the underside of plate 12 is a tubular outlet tube or duct 41 the inside peripheral surface of which registers with the curved surfaces 15 formed in the opening in plate 12 so that the tube 41 is in communication with the opening in the base plate 12. Tube or duct 41 extends downwardly from base plate 12 coaxially thereof, and is secured, as by welding, in a registering, circular opening formed in the center of an annular outlet flange or plate 42, the outer diameter of which is equal to the outer diameter of the base plate 12. Secured as by welding at its lower end coaxially to the outer peripheral surface of the outlet flange 42, and extending upwardly therefrom to surround the cartridge 30 in spaced relation thereto, is a circular housing 43, the upper end of which extends above the upper end of cartridge 30. Seated on the upper surface of the flange 42 within housing 43, and disposed in equi-angularly spaced relation about the axial centerline of the cartridge 30 is a plurality (six in the embodiment illustrated) of nuts 45, the bores of which register with circular openings 46 formed through the flange 42. The nuts 45 are threaded onto the upper ends of bolts B, such as those shown in phantom by broken lines in FIG. 1, which are employed for mounting the filter unit and associated cartridge 30 in the apparatus (not illustrated) employed for filtering air or gas. In this connection the lower, output end of the outlet duct or tube 41 would also at such time be connected to one end of a recirculating duct D or the like, which is also shown in phantom by broken lines in FIG. 1. At its opposite end duct D would be connected to a vacuum source, or the like, which would cause air or gas to be drawn into the top of housing 43, and through the perforations in cartridge 30 to the outlet duct 41.

From the foregoing, it will be apparent that the present invention provides an improved, replaceable, square filter cartridge which is made from a pleated filter element of pleated design, which provides a very large amount of surface area for filtering air or gas which is drawn through the numerous pleats in the filter element to the large, rectangular opening formed in the center of the filter cartridge. Moreover, instead of incorporating a rigid, reinforcing frame or body in the cartridge, the cartridge itself is coreless and is designed to be placed removably around a square, perforated metal basket section of a filter unit, which basket section is fixed within the filter unit, rather than being removable therefrom. As a result, the pleated filter cartridge which may be made from an inexpensive paper media, can be removed and replaced whenever necessary, at which time the remaining, perforated basket section 20 can be readily cleaned before inserting a new filter cartridge 30 thereover. With the construction disclosed herein a minimum amount of tools are required, simply, for purposes of replacement of the cartridge and cleaning of the basket section, one need only employ a wrench for removing and replacing the single nut 37 which is employed for releasably securing the cartridge 30 in an operative position within the filter housing 43. The internal fin assembly formed by the folded metal sheets 17 and 18 not only supplies a rigid, reliable support for the surrounding, perforated basket section composed of the perforated sheets 21 through 24, but also provides stable means for releasably securing the cover plate 36 over the upper end of a filter cartridge 30.

While in the illustrated embodiment the metal sheets 17 and 18 forming the fin assembly are made from only two-folded metal sheets, if desired the fin assembly could be made from four, like metal sheets each having one longitudinally extending edge thereof registering with the center of the base plate 12 and being welded or otherwise secured to each other along the axis of the base plate 12 so that all four plates would intersect at right angles to each other in the manner that the fin assembly is shown in FIGS. 2 and 3. Also, of course, the exact number of perforated plates needed for forming the square basket section 20 could vary without departing from this invention. Moreover, while the invention has been illustrated and described in connection with only certain embodiments thereof, it will be apparent that this application is intended to cover any such modifications as may fall within the scope of one skilled in the art, or the appended claims.

1. A filter cartridge assembly, comprising
a rigid base plate having therethrough a central, substantially rectangularly shaped opening,
an elongate, rigid, rectangularly shaped, perforated housing secured at one end thereof to one side of said base plate around said opening therein and having therethrough a central, rectangularly shaped opening registering with the opening in said base plate,
an elongate, rectangularly shaped filter cartridge comprising a pair of spaced, parallel, end caps each having therethrough a rectangularly shaped central opening, and an elongate, pleated, rectangularly shaped filter element secured at opposite ends thereof in said end caps, and having therethrough a rectangularly shaped central opening registering with the central openings in said end caps, and
means for removably and sealingly securing said cartridge around the outside of said perforated housing with one of said end caps thereof being seated against said base plate, and with the central opening in said cartridge communicating with the opening in said base plate,
said end caps being operative to maintain alternate fold lines of said pleated element in spaced, confronting relation to said perforated housing.

2. A filter cartridge assembly as defined in claim 1, including
a further, elongate housing surrounding said cartridge in spaced relation thereto, and being secured adjacent one end thereof to said base plate, and
an outlet duct secured at one end thereof to said base plate at the side thereof opposite said perforated housing and in communication with the central opening in said base plate,
said outlet duct disposed to have the opposite end thereof in communication with apparatus operative to draw fluid into the opposite end of said further housing and successively through said cartridge and said perforated housing to said outlet duct.

3. A filter cartridge assembly as defined in claim 1, including
an elongate, rigid fin assembly secured in the central opening in said perforated housing and extending between opposite ends thereof,
said fin assembly comprising a plurality of metal plates forming in said housing two elongate planar partitions each extending at right angles to and between a pair of opposed sidewalls of said housing, and intersecting each other at right angles at the center of said housing.

4. A filter cartridge assembly as defined in claim 3, wherein said two partitions extend into said opening in said base plate, and are secured to said base plate.

5. A filter cartridge assembly as defined in claim 3, wherein said means for removably securing the cartridge around the outside of said perforated housing comprises
a rigid cover plate removably overlying the upper end of said cartridge when said one end cap thereof is seated against said base plate, and
an externally threaded stud secured at one end thereof to the intersection of said planar partitions at the ends thereof remote from said base plate, and extending through a central opening in said cover plate and disposed to have a nut threaded thereover to secure said cover plate removably against the upper end of said cartridge.

6. A filter cartridge assembly as defined in claim 1, wherein the central openings in said cartridge and said end caps are square.

7. A filter cartridge assembly as defined in claim 2, wherein
said further housing is cylindrical in configuration, and
said base plate is circular and is secured coaxially in said further housing adjacent said one end thereof.

8. A filter cartridge assembly as defined in claim 7, wherein said base plate has formed in its outer peripheral surface a plurality of arcuate recesses equi-angularly spaced from each other about the axis of said base plate.

9. A filter cartridge assembly as defined in claim 7, including
an annular flange fixed coaxially to and projecting radially from the outer peripheral surface of said outlet duct in axially spaced relation to said base plate,
said flange being disposed coaxially in and secured to said further housing adjacent said one end thereof.

10. A filter cartridge assembly, comprising
an elongate housing having therethrough a central opening,
a rigid plate secured in said housing adjacent one end thereof, and having therethrough a central, substantially rectangularly shaped opening registering with the opening in said housing,
an elongate rectangularly shaped filter cartridge comprising a pair of spaced end caps, and an elongate, pleated, rectangularly shaped filter element secured at opposite ends thereof in said end caps and having therein a rectangularly shaped central opening,
means removably securing said cartridge in said housing in spaced relation thereto, and with one of said end caps being seated releasably against said base plate and having therethrough a central opening sealingly and releasably connected to the opening in said base plate, and
an outlet duct secured at one end thereof to said base plate at the side thereof opposite said cartridge and in communication with the central opening in said pleated filter element through the central openings in said base plate and said one end cap,
said outlet duct disposed to have the opposite end thereof connected to apparatus operative to draw fluid into the end of said housing remote from said base plate, and through said pleated filter element to said outlet duct.

11. A filter cartridge assembly as defined in claim 10, including
an elongate, rigid, rectangularly shaped, perforated housing mounted in said rectangularly shaped central opening in said pleated filter element, and in spaced, confronting relation to alternate fold lines in said pleated element, and
said perforated housing extending at one end thereof through said central opening in said one end cap, and being secured to said base plate around said central opening therein.

12. A filter cartridge assembly as defined in claim 11, including
an elongate, rigid fin assembly comprising a plurality of metal plates secured in the central opening in said perforated housing and extending between opposite ends thereof,
said metal plate forming in said housing two elongate, planar partitions each extending at right angles to and between a pair of opposed sidewalls of said perforated housing, and intersecting each other at right angles at the center of said perforated housing.

13. A filter cartridge assembly as defined in claim 12 wherein said rectangularly shaped central openings in said pleated filter element and in said perforated housing, are square in configuration

14. A filter cartridge assembly as defined in claim 12, wherein
the other of said end caps has therethrough a central opening which is rectangular in configuration and registers with the central opening in said pleated filter element,
a rigid, removable cover plate overlies said other end cap and the central opening therein, and
said means for securing said cartridge in said housing comprises means for releasably connecting said cover plate to said fin assembly and sealingly over the central opening in said other end cap.
